(19) United States
(12) Patent Application Publication
(10) Pub. No.: US 2006/0179056 A1
(43) Pub. Date: Aug. 10, 2006

(54) ENHANCED STORAGE AND RETRIEVAL OF SPATIALLY ASSOCIATED INFORMATION

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, Pismo Beach, CA (US)

(21) Appl. No.: 11/383,195

(22) Filed: May 12, 2006

Related U.S. Application Data
(60) Provisional application No. 60/726,344, filed on Oct. 12, 2005.

(51) Int. Cl. G06F 17/30

(52) U.S. Cl. 707/6

(57) ABSTRACT

Numerous embodiments exemplarily described herein offer a solution to the problem of overcrowding of spatially associated information by providing geo-demographic tags as a means of targeting spatially associated information at persons who meet certain demographic characteristics. In this way, a user who walks past a busy street corner can configure his or her portable computing device to alert him or her to information that is most appropriate for his or her personal demographic characteristics. In some embodiments, only information that is demographically relevant to a user will trigger an alert and/or be displayed by that user's portable computing device. In some embodiments, the plurality of distinct pieces of spatially associated information that are within a certain proximity of a given user will be presented to the user in a displayed order or hierarchy that is dependent upon the demographic relevance of that information to that particular user.

This application claims the benefit of U.S. Provisional Application No. 60/726,344, filed Oct. 12, 2005, which is incorporated in its entirety herein by reference.

### BACKGROUND

1. Field of Invention

Embodiments disclosed herein relate generally to the field of information stored and accessed based upon geographic locations.

2. Discussion of the Related Art

Many people wander about the physical world without realizing the wealth of information concerning their surroundings. For example, people travel in their own communities without knowing what buildings may be of historical significance or what shopping center may have a specific store or whether any store in the shopping center sells a specific product or whether a friend of their has visited this location in the past and had particular thoughts or comments. In addition, the natural world is abundant with location-related information that would be of interest to people—the names of particular trees, plants, landforms, bodies of water, and other natural landmarks that are fixed in location. In many instances, people rely on maps, field guides, brochures or other documents to familiarize themselves with their surroundings. These documents may include tourist/travel brochures, shopping mall directories/maps, park field guides or naturalist books, or other similar literature. However, these documents are not very informative because they contain limited amounts of information and are generally not useful on the fine identification of objects such as specific trees and plants. Also such printed information is generally not kept up to date as well as on-line information.

This lack of information often results in ineffective advertising for businesses and limited scientific information about natural phenomenon. For example, on a traditional map or brochure covering a city, business are not be able to provide the consumer with a list of products sold in a particular store nor can businesses indicate products that are currently on sale or otherwise featured. On a traditional map or guide covering a park, information can not be given that identifies the type and age and factual information associated with individual trees. Similarly, a local historical building may not be able to provide the public with detailed historical information concerning the significance of the site.

However, many entities, such as stores, parks, historical sites, and/or businesses now utilize distributed networks, such as the Internet and, more particularly, the World Wide Web portion of the Internet, to provide the public with useful information. For example, information about a historical site, such as a battlefield, may be disseminated via the World Wide Web and accessed though commercial Internet service providers (ISPs). The World Wide Web also provides the public with countless amounts of other information, such as business data, stock quotes or official government information.

However, a user will not have access to the desired information unless they manually input a web address or uniform resource locator (URL) associated with a particular web page. In these cases, it may be difficult to retrieve the web page because the URL may be unknown and/or difficult to locate, even with the sophisticated search engines currently available. Also, the web address may be very long which may result in a mistake when entering the web address. Also in many cases the user may be at a location and looking at an object in the distance, such as a tree or building or river or lake or hill or valley or outcropping of rock and may not know what kind of tree it is, what building it is, what the name or the river is, what the name of the lake is, how tall the hill is, what the name of valley is, or what kind of outcropping of rock it is. All the user may know is that the object is located near them as they wander a physical space. In such a circumstance, the user may not know how to search for a URL that would provide information about the particular tree or building or river or lake or hill or rock other object that they are then looking at and wondering about. Similarly, if a friend or associate of the user had visited that particular location and made a comment and put that comment on the internet, the user may not know how to access that location related content.

At the present time a number of emerging technologies have been developed to allow users to link informational content with locations. For example, a recently released software application called Google Earth allows users to interact with a scalable digital representation of the planet earth and link specific locations with informational tags. This has allowed users to link information about natural phenomenon, commercial businesses, and/or historical places to geographic locations such that users can access the information based upon the geographic location. A long term application of such technology may be to allow users wielding GPS enabled portable computing devices to access information that has been linked to spatial location based upon their current geographic location within the world. For example, a user who travels near a particular national monument could be able to access information about that national monument as a result of the specific GPS coordinates recorded by sensors local to his or her person. In this way, users in the future may be able to link information to spatial coordinates using tools like enhanced versions of Google Earth such that other users who are travel to a location physically proximal to where information has been linked may be alerted to and/or granted access to that spatially associated information. Similarly, users with portable computing devices, when traveling to a particular location, could be able to leave virtual notes and/or other informational content linked to the locations that they visit such that other users who travel to or near that same location be alerted to and/or granted access to that spatially associated information. Some early embodiments of such systems are described in the paper by Spohrer entitled Information in Places and published in IBM Systems Journal, vol. 38, No. 4, 1999 (p. 602-628), which is hereby incorporated by reference. Advanced embodiments for such systems are described in co-pending U.S. Provisional Patent Application Nos. 60/680,699 and 60/707,909, both of which are by the present inventor and both of which are hereby incorporated by reference.

A number of other systems have been developed for accessing spatially associated information, the information being accessed based upon the then current location of a portable computing system as determined by one or more Global Positioning System (GPS) sensor local to a computing system. For example, U.S. Pat. No. 6,122,520, entitled SYSTEM AND METHOD FOR OBTAINING AND USING LOCATION SPECIFIC INFORMATION and hereby incorporated by reference, describes a system that uses Navstar Global Positioning System (GPS) in combination with a distributed network to access location related information based upon GPS coordinates. In addition U.S. Pat. No. 6,819,267, entitled SYSTEM AND METHOD FOR PROXIMITY BOOKMARKS USING GPS AND PERVASIVE COMPUTING and hereby incorporated by reference, also describes a system for accessing location related information using GPS coordinates. In addition U.S. Patent Application Publication No. 2005/0032528, entitled GEOGRAPHICAL WEB BROWSER, METHODS, APPARATUS AND SYSTEMS and hereby incorporated by reference, also describes a system for accessing location related information using GPS coordinates.

While these systems provide certain important features they create the potential for information overload as a user wanders a physical space for particular physical locations and/or areas may be associated with a large number of different information files. For example, certain places such as street corners in busy cities or heavily trafficked paths within local parks will be packed with large amount of spatially associated information linked to the same or similar spatial locations or areas. This will be overwhelming for users who are looking for information. This will also be inefficient for users and organizations who have placed the information. For example, a business that places an information file at a certain location in space may find their information not being accessed by people who pass by that location because of the amount of competing information associated with the same or similar spatial locations.

It was a recognition of these and other problems associated with the prior art that formed the impetus for the embodiments described herein below.

### SUMMARY

Several embodiments exemplarily disclosed herein advantageously address the needs above as well as other needs by providing systems and methods enabling the storage and retrieval of spatially associated information.

In one embodiment exemplarily described herein, a spatial association method includes receiving geographic coordinates identifying a current physical location of a mobile computing device of a user, receiving demographic information identifying at least one current demographic characteristic of the user, and accessing a database containing a plurality of information files. Each of the plurality of information files is linked with at least one spatial coordinate and at least one geo-demographic tag. Subsequently, it is determined whether the physical location identified by the received geographic coordinates has a predetermined relationship with at least one spatial coordinate to which the plurality of information files are linked and whether at least one demographic characteristic identified by the received demographic information matches at least one geo-demographic tag to which the plurality of information files are linked. Next, an association message is transmitted to the mobile computing device. The association message is adapted to alert the user via the mobile computing device as to the presence of any information files linked both to at least one spatial coordinate determined to have the predetermined relationship with the physical location identified by the received geographic coordinates and to at least one geo-demographic tag determined to match at least one demographic characteristic identified by the received demographic information.

In another embodiment exemplarily described herein, a spatial association method includes receiving geographic coordinates identifying a current physical location of a mobile computing device of a user, accessing ambient information identifying at least one ambient condition present at the current physical location of the mobile computing device of the user, and accessing a database containing a plurality of information files. Each of the plurality of information files is linked with at least one spatial coordinate and at least one geo-ambient tag. Subsequently, it is determined whether the physical location identified by the received geographic coordinates has a predetermined relationship with at least one spatial coordinate to which the plurality of information files are linked and whether at least one ambient condition identified by the received ambient information matches at least one geo-ambient tag to which at least one of the information files are linked when at least one spatial coordinate is determined to have the predetermined relationship with the physical location identified by the received geographic coordinates. Next, an association message is transmitted to the mobile computing device. The association message is adapted to alert the user via the mobile computing device as to the presence of any information files linked both to at least one spatial coordinate determined to have the predetermined relationship with the physical location identified by the received geographic coordinates and to at least one geo-ambient tag matching at least one ambient condition identified by the accessed ambient information.

In yet another embodiment exemplarily described herein, a spatial association method includes receiving geographic coordinates identifying a current physical location of a mobile computing device of a user, receiving current speed information of the mobile computing device, and accessing a database containing a plurality of information files. Each of the plurality of information files is linked with at least one spatial coordinate and at least one speed-related mobility tag. Subsequently, it is determined whether the physical location identified by the received geographic coordinates has a predetermined relationship with at least one spatial coordinate to which the plurality of information files are linked and whether the current speed matches at least one mobility tag to which at least one of the information files are linked when at least one spatial coordinate is determined to have the predetermined relationship with the physical location identified by the received geographic coordinates. Next, an association message is transmitted to the mobile computing device. The association message is adapted to alert the user via the mobile computing device as to the presence of any information files linked both to at least one spatial coordinate determined to have the predetermined relationship with the physical location identified by the received geographic coordinates and to at least one mobility tag matching the current speed.

In still another embodiment exemplarily described herein, a spatial association system includes a server containing circuitry adapted to: receive geographic coordinates identifying a current physical location of a mobile computing device of a user; receive current demographic information identifying at least one current demographic characteristic of the user; access a database containing a plurality of information files, each of the plurality of information files being linked with at least one spatial coordinate and at least one geo-demographic tag; determine whether the physical location identified by the received geographic coordinates has a predetermined relationship with at least one spatial coordinate to which the plurality of information files are linked; determine whether at least one demographic characteristic identified by the received demographic information matches at least one geo-demographic tag to which the plurality of information files are linked; and transmit an association message to the mobile computing device, the association message adapted to alert the user via the mobile computing device as to the presence of any information files linked both to at least one spatial coordinate determined to have the predetermined relationship with the physical location identified by the received geographic coordinates and to at least one geo-demographic tag determined to match at least one demographic characteristic identified by the received demographic information.

### BRIEF DESCRIPTION OF THE DRAWINGS

The above and other aspects, features and advantages of several embodiments, will be more apparent from the following more particular description thereof, presented in conjunction with the following drawings.

FIG. 1 illustrates a schematic representation of one embodiment of a spatial association system;

FIG. 2 illustrates one embodiment of a portable computing device included within a spatial association system; and

FIG. 3 illustrates a generalized block diagram of one embodiment of a portable computing device.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

The following description is not to be taken in a limiting sense, but is made merely for the purpose of describing the general principles of exemplary embodiments. The scope of the invention should be determined with reference to the claims.

Numerous embodiments exemplarily described herein offer a solution to the problem of overcrowding of spatially associated information by providing geo-demographic tags as a means of targeting spatially associated information at persons who meet certain demographic characteristics. In this way, a user who walks past a busy street corner can configure his or her portable computing device to alert him or her to information that is most appropriate for his or her personal demographic characteristics. In some embodiments, only information that is demographically relevant to a user will trigger an alert and/or be displayed by that user's portable computing device. In some embodiments, the plurality of distinct pieces of spatially associated information that are within a certain proximity of a given user will be presented to the user in a displayed order or hierarchy that is dependent upon the demographic relevance of that information to that particular user. In some embodiments, methods and systems are provided that enable organizations and/or users who generate and/or link information to spatial locations and/or areas to also tag that information with specific demographic characteristics. In this way, an organization can identify which types of users, for example by age, gender, socioeconomic status, highest level of education, income level, sexual orientation, political party, organizational affiliations, team affiliations, school affiliations, professional affiliations, number of dependents, ages of dependents, hobbies, and/or interests, should be alerted to and/or be granted access to a piece of spatially associated information (i.e., an information file) when they come within a certain proximity of it.

Numerous embodiments described herein also offer a solution to the problem of overcrowding of spatially associated information by providing methods and systems by which geo-ambient tags may be associated with information files, linking that information not only to a specific location in the physical world but also specifying one or more variable ambient conditions that must be satisfied for users to be alerted to and/or granted access to the information. Geo-ambient tags may include, for example time-of-day tags, weather condition tags, day-of-week tags, and/or season-of-year tags. For example, using these methods and systems, a piece of spatially associated information may be linked to a particular time-of-day or range of time-of-day, for example “rush hour” periods for a particular street corner defined as between 4:00 PM and 7:00 PM. By linking a particular information file to such a time range using geo-ambient tags, users will only be alerted to such information and/or granted access to such information when they pass within a certain proximity of the link location for that information within those particular times.

In addition a plurality of geo-demographic tags and/or geo-ambient tags may be used in combination to further restrict the conditions and/or user qualities for which the information is associated. In this way, the large amount of information that may be associated with a particular geographic location and/or geographic area may be limited to a manageable set of information that is presented to a particular user based upon the particular demographic characteristics of that user and/or the particular ambient conditions of that point in time.

As described above, numerous embodiments exemplarily described herein provide spatial association methods and spatial association systems for storing and accessing digital information based upon spatial locations and/or spatial areas within the real physical world.

In one embodiment, a spatial association system for storing and accessing digital information based upon spatial locations and/or spatial areas within the real physical world includes a spatial association server (also referred to herein simply as a “server”) is provided for linking accessible digital information to spatial locations and/or spatial areas within the real physical world. The server may be a single server, a network of servers, or a plurality of independently operated servers such that the servers provide associations between specific spatial locations and/or spatial areas within the in the real physical world and specific digital information content. For purposes of discussion, a “spatial location” in the real physical world is a discrete location, usually defined by spatial coordinates (also referred to herein as locative coordinates, geographic coordinates, and the like) in the real physical world. Further, and for purposes of discussion, a “spatial area” is a range of locations that fall within certain boundaries or boarder within the real physical would and is usually defined as by a set of spatial coordinates and/or one or more spatial coordinates combined with a mathematical area or volume definition that is considered with respect to the one or more spatial coordinates. For example, a circular area of radius “r” may be defined around a particular spatial coordinate as a means of defining a spatial area within the context of the embodiments disclosed herein. In many embodiments, spatial location and/or spatial areas are defined using a global coordinate system of latitude values, longitude values, and optionally elevation values. In addition, spatial location and/or spatial areas may be defined as having directional values associated with them such as degrees away from magnetic north. In this way, a spatial location and/or spatial area may also have directionality associated with it. Although these coordinates are most commonly used, other coordinate systems and/or locative conventions may be used to achieve the same goals. The spatial association server includes circuitry and memory for linking digital information to spatial locations and/or spatial areas within the real physical world. Such digital information may include textual content, numerical content, image content, movie content, sound content, music content, and/or any other forms of information.

In one embodiment, the spatial association system also includes one or more portable computing devices for use by users with wireless communication capabilities for accessing the spatial association server. The portable computing device also includes position sensing transducers for determining a current position of the portable computing device as the user moves about the real physical world. As used herein, the term “current” means substantially current, or belonging to a substantially present time; acknowledging that there could be some small time delay. Thus, a “current” position of a portable computing device at time t may not necessarily refer to the position of the portable computing device at time t but may, instead, refer to the position of the portable computing device a fraction of a second before time t. In many embodiments, the position sensing transducer is a GPS transceiver for determining current latitude, longitude, and optionally elevation coordinates for the portable computing device as the user of that device moves about the real physical world. The portable computing device may also include orientation sensing transducers for determining a current orientation of the portable computing device (or a portion thereof) as the user moves about the real physical world. The orientation sensing transducer may include, for example, a magnetometer and/or an accelerometer for detecting orientation values. In general, orientation values are detected with respect to magnetic north and/or the direction of gravity. In addition, the portable computing device may be configured to store a time-history of positional values, the time-history of positional values being used by circuitry upon the portable computing device and/or upon the spatial association server to determine a direction of motion and/or a rate of motion of the portable computing device as manipulated by the user as he or she moves about the real physical world.

In some embodiments, the portable computing device may include an RFID scanner, a barcode scanner, and/or other means by which spatial coordinate information may be accessed with respect to the surroundings by reading and/or receiving locally encoded data. Such information may be used instead of or in combination with coordinate information derived from GPS transducers. In particular, such methods may be used in indoor situations wherein GPS transceivers may not be effective. Such information may also be used to supplement the spatial resolution provided by GPS transceivers. That said, numerous embodiments will be herein described primarily with respect to GPS transceivers for that is the most common current method by which a portable computing device may access locative coordinates within the real physical world. It will be appreciated, however, that this does not limit the scope of discussion of the methods and systems described herein solely to the use of GPS transceivers.

As described herein, portable computing devices such as those described above, working in combination with the aforementioned spatial association server, enable one or more users to be alerted to and/or access spatially associated information based upon that user's physical location as he or she traverses the real physical world. More specifically, a user of a portable computing device equipped with a GPS sensor (or other locative sensor) can be alerted to and/or be provided access to a particular piece of spatially associated information based upon that user's current physical location being within certain proximity of a certain spatial location in the real world and based upon certain conditions being satisfied. Such other certain conditions include one or more geo-demographic tags associated with the particular information file matching certain demographic characteristic(s) of the user and/or one or more geo-ambient tags associated with the particular information file matching certain current ambient characteristics at that certain spatial location. As used herein, “current ambient characteristics” at a certain spatial location may include the current time-of-day at that location, the current day-of-week at that location, the current month-of-year at that location, the current season-of-the-year at that location, and/or the current weather conditions at that location. Current weather conditions may include the current temperature, the current cloud conditions, the current chances of precipitation, the type and presence of precipitation, the recent accumulation of precipitation, the presence of fog, the presence of storms, the wind conditions, the sun conditions, the smog conditions, the allergy conditions, and/or the UV index at that location.

For example, a user may be alerted to and be provided access to information linked to specific landmarks, businesses, historical places, parks, and/or other physical locations as that user visits, approaches, and/or nears in the real world. In many embodiments, a user may be alerted to and/or granted access to such spatially associated information upon the server transmitting an association message to a device (e.g., a mobile computing device) held by the user. The information may be text, images, videos, sounds, music, or other common forms of digitally stored media. In this way, a user may wander about the real world and be alerted to and/or granted access to digital information that is linked to physical locations or areas within his or her proximity depending upon whether or not certain geo-demographic tags associated with that information match certain demographic characteristics stored for that user and/or depending upon whether or not certain current ambient characteristics of the physical location match certain geo-ambient tags associated with that information. By “match” it is meant that a certain characteristic is the same as a characteristic stored as a tag and/or falls within a range of values for that characteristic or condition defined by the tag. For example, a geo-ambient tag may specific a particular temperate range for which the piece of spatially associated information it is associated with may be alerted to a user and/or granted access to a user. If the current ambient air temperate at the location of the user falls within the particular temperature range when that user comes within a required or defined proximity of a location to which the spatially associated information is liked, the user will be alerted to and/or provided access to the information (assuming all other required geo-ambient tags and/or geo-demographic tags are satisfied).

The spatially associated information, as used herein, may be any information that is linked to a particular spatial location or area (via one or more spatial coordinates) in the real physical world. The information may be factual information provided by an organization, personal notes left by other wandering users, or other types and kinds of information that may be stored and accessed based upon spatial location or area. Users may be provided with alerts to and/or access to spatially associated information based upon their current location coming within certain proximity of (i.e., having a predetermined relationship with) the one or more spatial coordinates and based upon certain conditions being met, said certain conditions involve one or more geo-demographic tags and/or geo-ambient tags associated with the particular piece of spatially associated information.

According to numerous embodiments, a system for storing and accessing digital information based upon spatial locations and/or spatial areas within the real physical world may be implemented as a computer moderated system that conditionally provides alerts and/or access to spatially associated information to users when they come within a certain physical proximity of a spatial location or spatial area that has information is associated with it. More specifically, the computer moderated system may provide alerts and/or access to spatially associated information to a user when he or she comes within a certain physical proximity of a spatial location or spatial area that has a particular piece information is associated with it and when certain predefined conditions are met are represented by one or more geo-demographic tags and/or geo-ambient tags associated with that particular information file. As disclosed herein, the certain proximity may be a distance range or a proximity area. As disclosed herein, the certain proximity may be a fixed value or may be dependent upon the current direction of motion and/or speed of motion of the user. As disclosed herein, an “alert” that informs a user as to the presence of a piece of spatially associated information is a visual, auditory, and/or tactile cue provided by the portable computing device (or a peripheral thereof) to a user to inform the user as to the presence of a piece of spatially associated information that he or she is then currently near. The cue may be provided in a selectable form that further informs the users as to the type, importance, relevance, and/or proximity of the spatially associated information that he or she is then currently near.

According to numerous embodiments, a system for storing and accessing digital information based upon spatial locations and/or spatial areas within the real physical world is operative to provide real-time sensory alerts to a user as he or she walks about a physical space, the real time alerts being provided to inform the user that he or she has come within a certain proximity of a piece of spatially associated information if one or more conditions are satisfied such that the user has one or more demographic characteristics specified within the geo-demographic tags associated with that information file and/or if the physical location of the user meets one or more ambient characteristics specified by the ambient tags associated with that information file. In this way, a user can wander a crowded space and be made aware of information that is more likely to be relevant to that user.

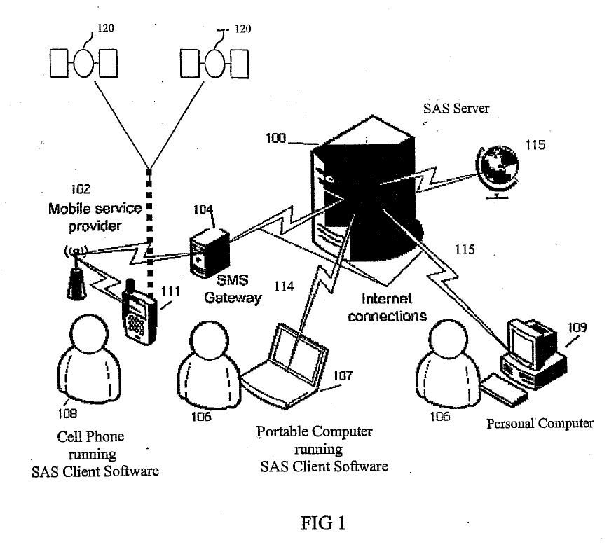

FIG. 1 illustrates a schematic representation of one embodiment of a spatial association system. Referring to FIG. 1, a spatial information system that enables users of portable computing devices (for example user 106 and user 108) to receive conditional alerts regarding and/or to be conditionally provided access to spatially associated information when they come within a certain proximity of a spatial location and/or spatial area for which that spatially associated information is linked. As represented in FIG. 1, the spatial association system is comprised of the aforementioned spatial association server (SAS) server or a group of SAS servers that contain circuitry to support the spatial association between information and physical locations and/or areas. This server or group of servers is referred to herein simply as the SAS server 100. The SAS server 100 contains circuitry (i.e., SAS server circuitry) adapted to associate spatial locations and/or spatial areas with pieces of digital information. As used herein, the term “circuitry” refers to any type of executable instructions that can be implemented, for example, as hardware, firmware, and/or software, which are all within the scope of the various teachings described. A piece of digital information may include text, images, numerical data, videos, sounds, music, web pages, URL locations, and/or any other common forms of digitally stored information or media.

The server circuitry is adapted to maintain and/or access a database of spatial locations and/or spatial areas, each spatial location and/or spatial area being linked to one or more information files. Such a database is referred to herein as a SAS database. The SAS database may be maintained on a single computer or a plurality of computers. In general, a single spatial location and/or spatial area may be associated with a plurality of distinct information files within the SAS database. Each piece of spatially associated information referenced in the SAS database is also optionally associated with one or more geo-demographic tags. Geo-demographic tags are one or more demographic characteristics of accessing users that must be satisfied in order for a user to be alerted to the piece of spatially associated information and/or in order for the user to access the piece of spatially associated information. Each piece of spatially associated information referenced in the SAS database is also optionally associated with one or more geo-ambient tags. Geo-ambient tags are or more ambient conditions that the current spatial location of the user (when that user is within sufficient proximity of a piece of spatially associated information) must satisfy in order for that user to be alerted to that piece of spatially associated information and/or in order for the user to be provided access to that piece of spatially associated information.

Geo-Demographic tags are associated with particular pieces of spatially associated information and indicate one or more particular demographic characteristic of users who are most appropriate to be alerted to and/or to be granted access to that information. For example, by using geo-demographic tags, an information file referenced within the SAS database may be associated with a particular demographic characteristic such as gender such that only users who are identified by personal data associated with them as belonging to that gender will be alerted to and/or granted access to that piece of spatially associated information when coming within a certain proximity of it.

Similarly, an information file referenced within the SAS database may be associated with a particular demographic characteristic such as age range such that only users who are identified through personal data associated with them as falling within a certain age range will be alerted to and/or granted access to that piece of spatially associated information when coming within a certain proximity of it.

Similarly, an information file referenced within the SAS database may be associated with a particular demographic characteristic such as personal hobby or interest such that only users who are identified by personal data associated with them as having that personal hobby or interest will be alerted to and/or granted access to that piece of spatially associated information when coming within a certain proximity of it.

Similarly, an information file referenced within the SAS database may be associated with a particular demographic characteristic such as income level such that only users who are identified through personal data associated with them as having an income level that exceeds a certain value or fall within a certain range will be alerted to and/or granted access to that piece of spatially associated information when coming within a certain proximity of it.

Similarly, an information file referenced within the SAS database may be associated with a particular demographic characteristic such as job title such that only users who are identified though personal data associated with them as having that job title (or a similar job title) will be alerted to and/or granted access to that piece of spatially associated information.

Similarly, an information file referenced within the SAS database may be associated with a particular demographic characteristic such as highest level of education such that only users who are identified though personal data associated with them as having achieved a certain highest level of education will be alerted to and/or granted access to that piece of spatially associated information.

Similarly, an information file referenced within the SAS database may be associated with a particular demographic characteristic such as current grade level such that only users who are identified though personal data associated with them as currently being in a certain educational grade level (i.e. first grade, third grade) and/or falling within a certain range of grade levels will be alerted to and/or granted access to that piece of spatially associated information.

Similarly, an information file referenced within the SAS database may be associated with a particular demographic characteristic such as profession such that only users who are identified though personal data associated with them as belonging to that profession or group of professions will be alerted to and/or granted access to that piece of spatially associated information.

Similarly, an information file referenced within the SAS database may be associated with a particular demographic characteristic such as marital status such that only users who are identified though personal data associated with them as having a certain marital status will be alerted to and/or granted access to that piece of spatially associated information.

Similarly, an information file referenced within the SAS database may be associated with a particular demographic characteristic such as political party affiliation such that only users who are identified though personal data associated with them as belonging to or being affiliated with a particular political party will be alerted to and/or granted access to that piece of spatially associated information.

Similarly, an information file referenced within the SAS database may be associated with a particular demographic characteristic such as a club, team, or organizational affiliation such that only users who are identified though personal data associated with them as belonging to or being affiliated with a particular club, team, or organization will be alerted to and/or granted access to that piece of spatially associated information.

Similarly, an information file referenced within the SAS database may be associated with a particular demographic characteristic such as a school affiliation such that only users who are identified though personal data associated with them as belonging to or being affiliated with a particular school will be alerted to and/or granted access to that piece of spatially associated information.

Similarly, an information file referenced within the SAS database may be associated with a particular demographic characteristic such as a nationality such that only users who are identified though personal data associated with them as being a citizen of a particular country will be alerted to and/or granted access to that piece of spatially associated information.

Similarly, an information file referenced within the SAS database may be associated with a particular demographic characteristic such as a family affiliation such that only users who are identified though personal data associated with them as belonging to or being affiliated with a particular family will be alerted to and/or granted access to that piece of spatially associated information.

Similarly, an information file referenced within the SAS database may be associated with a particular demographic characteristic such as a membership to a particular circle of friends such that only users who are identified though personal data associated with them as belonging to a particular circle of friends will be alerted to and/or granted access to that piece of spatially associated information.

Similarly, an information file referenced within the SAS database may be associated with a particular demographic characteristic such as the number of dependents and/or ages of the dependents of the user. In this way, for example, only users who have kids within a certain age range will be alerted to and/or granted access to that piece of spatially associated information.

Geo-ambient tags are associated with particular pieces of spatially associated information and indicate one or more preferred ambient characteristic of the location at which a user is currently at when coming within a certain proximity of a piece of spatial associated information. For example, by using geo-ambient tags an information file referenced within the SAS database may be associated with ambient information identifying an ambient condition (e.g., a particular ambient air temperature range) such that only when the current air temperature as recorded by the portable computing device of the user who is wandering a particular space is within a certain range of temperature values with that user be alerted to and/or granted access to that piece of spatially associated information when coming within a certain proximity of it. In such embodiments, temperature conditions may be accessed from a weather information server, indexed by the spatial location data identifying the geographic coordinates captured by the portable computing device of the user. For example, a warning message “Caution Black Ice” may be linked to a particular spatial location and/or spatial area upon a path in a national park that tends to get sheeted with ice when the temperatures are below a certain level. This piece of spatially associated information may also be linked to a geo-ambient tag that associates the information with a temperature range below 38 degree Fahrenheit. In this way, users who wander the path and come within a certain proximity of the black-ice prone patch will be alerted to the spatially associated warning message only if the current outdoor temperate is below 38 degrees Fahrenheit. Thus, when the weather is too warm for black ice the system does not trigger an alert and/or provide access to that particular information file thereby reducing unnecessary information clutter for the user.

Similarly, an information file referenced within the SAS database may be associated with ambient information identifying an ambient condition (e.g., cloud cover) such that only when the current cloud cover conditions for the location of a user is of a certain type or level will the user be alerted to and/or granted access to that piece of spatially associated information when coming within a certain proximity of it. In such embodiments, cloud cover conditions may be accessed from a weather information server, indexed by the spatial location data identifying the geographic coordinates captured by the portable computing device of the user. For example, if it is determined that “clear skies” are currently present at the spatial location of a user who wanders past a particular concession stand in a state park, that user may be alerted to and/or granted access to information about sunscreen products that are spatially linked to the geographic location of that concession stand.

Similarly, an information file referenced within the SAS database may be associated with ambient information identifying an ambient condition (e.g., current precipitation) such that only when the current precipitation conditions for the location of a user is of a certain type or level will the user be alerted to and/or granted access to that piece of spatially associated information when coming within a certain proximity of it. In such embodiments, precipitation conditions may be accessed from a weather information server, indexed by the spatial location data identifying the geographic coordinates captured by the portable computing device of the user. For example, if it is determined that it is “raining” currently at the spatial location of a user who wanders a particular path in a state park, that user may be alerted to and/or granted access to information about mud-slide warnings. Similarly, pieces of spatially associated information may be linked in this way to snow flurries, snow fall, and/or blizzard conditions.

Similarly, an information file referenced within the SAS database may be associated with ambient information identifying an ambient condition (e.g., UV Index, Smog Index, and/or Pollen Count), such that only when the current UV Index, Smog Index, and/or Pollen Count conditions for the location of a user is of a certain type or level will the user be alerted to and/or granted access to that piece of spatially associated information when coming within a certain proximity of it. In such embodiments, UV Index, Smog Index, and/or Pollen Count index conditions for a particular location may be accessed from a weather information server (or other similar server), indexed by the spatial location identifying the geographic coordinates captured by the portable computing device of the user.

Similarly, an information file referenced within the SAS database may be associated with ambient information identifying an ambient condition (e.g., time-of-day at the location) such that only when the current time-of-day for the location of a user who comes within proximity of the spatially associated information (considering local time zones) is of a certain time or within a certain range of times will the user be alerted to and/or granted access to that piece of spatially associated information when coming within a certain proximity of it. In such embodiments, the current time-of-day (considering local time zones) may be accessed from an information server, indexed by the spatial location data identifying the geographic coordinates captured by the portable computing device of the user.

Similarly, an information file referenced within the SAS database may be associated with ambient information identifying an ambient condition (e.g., day-of-week) such that only when the current day of the week for the location of a user is of a certain day or within a certain set or range of days will the user be alerted to and/or granted access to that piece of spatially associated information when coming within a certain proximity of it. In such embodiments, the day-of-week may be accessed from an information server, indexed by the spatial location data identifying the geographic coordinates captured by the portable computing device of the user. For example, a particular piece of spatially associated information linked to a particular location can also be liked by geo-ambient tag to Mondays, Wednesdays, and Fridays such that only when a user comes within a certain proximity of that information on Mondays, Wednesday, and Fridays will the user be alerted to and/or granted access to the information.

Similarly, an information file referenced within the SAS database may be associated with ambient information identifying an ambient condition (e.g., month-of-year) such that only when the current month for the location of a user is of a certain month or within a certain set or range of months will the user be alerted to and/or granted access to that piece of spatially associated information when coming within a certain proximity of it. In such embodiments, the current month-of-year may be accessed from an information server, indexed by the spatial location data identifying the geographic coordinates captured by the portable computing device of the user. For example, a particular piece of spatially associated information linked to a particular location can also be liked by geo-ambient tag to April and May such that only when a user comes within a certain proximity of that information during the months of April and May, will the user be alerted to and/or granted access to the information. Such a feature could be used for spatially associated information associated with a particular flower at a particular location that only blooms during the months of April and May.

Similarly, an information file referenced within the SAS database may be associated with ambient information identifying an ambient condition (e.g., season of the year) such that only when the current season for the location of a user is of a certain season will the user be alerted to and/or granted access to that piece of spatially associated information when coming within a certain proximity of it. In such embodiments, the current season-of-year may be accessed from an information server, indexed by the spatial location data identifying the geographic coordinates captured by the portable computing device of the user. For example, a particular piece of spatially associated information linked to a particular location can also be liked by geo-ambient tag to winter such that only when a user comes within a certain proximity of that information during the winter will the user be alerted to and/or granted access to the information.

As an example of the value of geo-demographic tags for educational applications as mentioned above, a piece of spatially associated information may be liked to a grade level and/or grade range of uses for whom the information is intended and/or appropriate. For example, certain information may be educational and may be appropriate for and/or intended for users who are in first and second grade. Such information may therefore be associated with a geo-demographic tag that identifies it as intended for people who posses demographic characteristics indicating that they are in the first or second grades. Other information may be appropriate for and/or intended for users who are in high school. Such spatially associated information may therefore be associated with a geo-demographic tag that identifies it as intended for high school grade levels. Thus, a first or second grade student can, for example, wander a park and be alerted to and/or provided access to spatially associated information about various aspects of the park, that information being specifically tagged intended for first and second graders. A high school student may wander the very same physical space and using the inventive methods and systems described herein be alerted to and/or granted access to different information that is linked to the same or similar spots, the high school student being alerted to and/or provided access to is appropriate for and/or intended for high school students. In this way, a plurality of users can wander the same space and be alerted only information that is relevant to them. This is particularly useful for the educational applications disclosed herein wherein particular users are alerted to spatially associated information as they wander a physical space that is intended for grade level of that user.

As described previously, the spatial association system not only allows users to conditionally access information based upon their current location in the physical world, the system also enables users to create information and link it to particular spatial locations and/or spatial areas in the physical world. One example of such authoring functions enables a user to leave a virtual note in the physical world for other users to find and read. When a user leaves such an authored piece of spatially associated information using the methods and systems described herein, the user may specify one or more geo-demographic tags and/or geo-ambient tags for association with the piece of authored spatially associated information, the geo-demographic tags and/or geo-ambient tags affecting the conditional alerting of and/or conditional accessing of that information by other users when they come within proximity of it. For example, a particular user might leave a virtual note on a street corner commenting on the three nearby women's clothing stores that she particularly likes. The user might craft this note using a personal computer or portable computing device and might link the note to the particular street corner by typing in the GPS location for the street corner or by selecting the street corner using an on-line mapping program such as Google Earth. The user may also use the user interface of his or her computing device to link the spatially associated information with a geo-demographic tag that indicates that only users who have a gender of female should be alerted to and/or granted access to the information. The user may execute this function by selecting a menu upon the user interface, choosing gender from among a plurality of selections within the menu, and then setting the gender parameter to female. In this way, the geo-demographic tag associated with the particular piece of spatially associated information (i.e., the virtual note) is set by the author to a gender characteristic of female. Thus, when other users travel physically to that particular street corner and come within a certain proximity of the street corner, those users who have are of gender female (as indicated within a personal data file for the user) will be alerted to and/or provided access to the particular piece of spatially associated information (i.e. the virtual note about the three woman's clothing stores). Male users on the other hand (as indicated by the gender parameter within personal data files for each user) will not be alerted to and/or provided access to the virtual note and thereby will not be bothered by spatially associated information they are likely not to be interested in. Similarly, the user may also use the user interface of his or her computing device link the spatially associated information with another geo-demographic tag that indicates that only user's who are older than 12 years old should be alerted to and/or granted access to the information by setting the age range demographic characteristics. The user may execute this function by selecting a menu upon the user interface, choosing age from among a plurality of selections within the menu, and then setting the age parameter to older than 12 years old. In this way, the geo-demographic tag associated with the particular piece of spatially associated information (i.e. the virtual note) is set by the author to a gender characteristic of female and an age characteristic of older than 12 years old. Thus, when other users travel physically to that particular street corner and come within a certain proximity of the street corner, those users who have are of gender female and an age of older than 12 years old (as indicated within a personal data file for the user) will be alerted to and/or provided access to the particular piece of spatially associated information (i.e. the virtual note about the three woman's clothing stores). Other users who do not posses that combination of demographic characteristics will not be alerted to and/or provided access to the particular piece of spatially associated information.

As an alternate example, a particular user who is an alumni of a particular university, for example Stanford University, might wander a particular place such as San Francisco, and leave comments and/or insights and/or observations as textual notes or other forms of information media linked to specific locations around the city. That user may use the user interface of his or her computing device to associate a Demographic Tag with the information he or she leaves indicating that users must be alumni of Stanford University will be alerted to and/or granted access to the information when they come within certain proximity of the information. In this way, a plurality of alumni to Stanford University may wander the city and have a unique experience of sharing spatially associated information (i.e. linked virtual notes that include comments and observations and insights) that have been left by and are accessible only by other alumni to the University. This allows Stanford Alumni to have a spatial experience within San Francisco that would be unique and distant from other groups, for example Berkeley Alumni, who might leave notes and linking their spatially associated notes to geo-demographic tags such that only other alumni of Berkeley will be alerted to and/or granted access to the information when they come within a certain proximity of the information. Thus, Stanford and Berkeley alumni can wander the same space and have very different and customized interactions with spatially associated information. To prevent Berkeley Alumni from leaving offensive notes and linking those notes to geo-demographic tags such that they are intended for alumni of their rival Stanford, the spatial association system an option for a password feature and/or other authorization feature that prevents a user from linking an information file with some demographic characteristics (such as membership in certain groups or associations) unless they are in possession of the password or are otherwise authorized or authenticated as a member of the group or association for which they are leaving information.

Referring back to FIG. 1, the spatial association system includes one or more portable computing devices (for example laptop 107 and cell phone 111) configured to communicate with the SAS server and thereby generate alerts when a user comes within a certain proximity of a piece of spatially associated information conditional upon satisfying some and/or all geo-demographic tags and/or geo-ambient tags associated with that piece of spatially associated information. In general, the portable computing device contains client circuitry (i.e., SAS client circuitry) adapted to moderate the communication with the SAS server and enable the portable computing device to generate and impart the appropriate alerts upon the user based upon the then current location of the user as well as any associated qualifier tags. In one embodiment, the SAS client circuitry enables users to select and/or author and/or modify information, link that information to a particular spatial location, and link the spatially associated information with one or more geo-demographic tags and/or geo-ambient tags. To perform these functions (herein referred to as “authoring functions” that include creating information, linking it to a spatial location, and/or linking it with one or more geo-demographic tags and/or geo-ambient tags), a user may interact with a portable computing device (for example laptop 107 and cell phone 111) or a personal computer (for example 109) and use authoring tools, mapping tools, and user interface functions, supported by the SAS client circuitry, that allow selection and identification of geo-demographic tags and/or geo-ambient tags. In many embodiments, the computer used for authoring (107, 111, or 109) interacts with the SAS server, communicating data representing the linkages between the authored information file and a particular spatial location or area and the linkages between the authored information file and particular geo-demographic tags and/or geo-ambient tags.

In one embodiment, the portable computing device contains within it and/or is connected to one or more locative sensors. The SAS client circuitry is operative to access data from the one or more locative sensors to determine a current position of the user various points in time. The SAS client circuitry may also be operative to store a time history of locative sensor data to determine a current speed of motion, direction of motion, and/or trajectory of motion (collectively referred to herein as “mobility conditions”) of the user at various points in time. In some embodiments, a user must not only come within a certain proximity of a piece of spatially associated information, the user must also approach from a particular direction (or range of directions) and/or approach with a particular speed (or range of speeds) alerted to and/or be granted access to that piece of spatially associated information. A mobility condition may include, for example, a required direction (or range of directions) of approach to a particular piece of spatially associated information such that a user must approach from such a direction to be alerted to and/or provided access to the information file. A mobility condition may include, for example, a maximum speed of approach to a particular piece of spatially associated information such that a user must approach from at a speed below the maximum value to be alerted to and/or be provided access to the information file. A mobility condition may include, for example, a minimum speed of approach to a particular piece of spatially associated information such that a user must approach from at a speed above the minimum value to be alerted to and/or be provided access to the information file. To support such functionality, each information file referenced in the SAS database may be associated with one or more mobility tags identifying mobility conditions that must be satisfied in order for a user to be alerted to the information and/or in order for the user to access the information.

In many embodiments, the locative sensors include one or more GPS transducers that provide current spatial location information for the portable computing device by receiving data from orbiting satellites 120. The GPS transducer is operative to provide latitude, longitude, and altitude coordinates to the SAS client circuitry. The locative sensors may also include other sensors such as a directional sensor such as a magnetometer and/or accelerometer that provides directional data. In general, the SAS client circuitry accesses the locative sensor data at a rapid and regular interval such that it has access to substantially current mobility information for the user in possession of the portable computing device. The current mobility information generally includes spatial coordinates (such as latitude and longitude) identifying the geographic location of the user. The current mobility information may also include altitude, orientation, speed, direction of motion, trajectory of motion, etc.

An information file referenced in the SAS database may also be associated with a particular direction that a user must be facing and/or moving to be alerted to that information file. The direction may be specified a range of values thereby expressing a range of acceptable directions that the user must be facing and/or moving to be alerted to the associated information file. Each information file referenced in the SAS database may also be associated with a particular distance of influence or area of influence, for example a distance within which or an area within which a user must be located to be alerted to that information file. In this way, an information file that refers to something large like a tall building may trigger an alert to users who are a large distance away while an information file that refers to something small, like a flower may trigger an alert only for users who come within a very small distance or area of its location. Each information file referenced in the SAS database may also be associated with a particular speed of motion, for example a speed below which a user must be moving to be alerted to that information file. In this way, an information file that refers to something large like a tall building may trigger an alert for a quickly moving user while an information file that refers to something small, like a flower may only trigger alerts for users who pass by below a certain speed. Furthermore, a single information file within the SAS database may be associated with a plurality of the user mobility conditions mentioned above. For example, a single information file may be associated with a particular direction of motion, a particular influence distance, and a particular speed of motion such that a user must be moving in a particular direction motion, must be within a certain influence distance of the location that the information is associated with, and must be moving below a particular speed, for that user to be alerted to and/or granted access to the particular information file

As also shown in FIG. 1, each of the aforementioned portable computing devices include a communication link, generally a wireless communication link, to a network such as the Internet and/or cellular network that enable the portable computing device to exchange data with the SAS server. In one embodiment, the spatial association system may be implemented as a managed service (e.g., in an ASP model) using a SAS server 100, which is connected or connectable to one or more networks. For illustrated purposes, the SAS server is illustrated as a single machine, but one of ordinary skill will appreciate that this is not a limitation. More generally, the service may be provided by an operator using a set of one or more computing-related entities (systems, machines, processes, programs, libraries, functions, or the like) that together facilitate or provide the inventive functionality described herein. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-accessible Internet, a corporate intranet, a private network, or any combination thereof, depending on the desired implementation environment. As illustrated FIG. 1, the SAS server 100 is also in communication with a mobile service provider (MSP) 102 through a gateway, such as SMS gateway 104.

As also illustrated in FIG. 1, one or more users 106 may register for the service, typically by using a client machine which may be the portable computing device 111 or some other machines such as a personal computer 107. When a personal computer is used, registration is initiated by an end user opening a Web browser to the operator's Web site registration page (or set of registration pages). When a portable computing device is used, registration may be initiating through a mini-browser or other similar interface. These techniques are merely representative, as any convenient technique (including, without limitation, email, filling out and mailing forms, and the like) may be used. Thus, in the illustrated embodiment, users register with the SAS server 100 (or set of servers) either through Internet connections from personal computers, or via remote registration through a mobile device. The registration process may include the user entering and/or setting user preferences about the type, classification, and/or other conditional aspects of being alerted to spatially associated information as they user comes within proximity of such information. The registration process may also include the user entering and/or setting demographic information about himself or herself, including for example the user's age, gender, grade level, highest level of education, income level, sexual orientation, political party affiliation, organizational affiliations and/or memberships, team affiliations, school affiliations, professional affiliations, job title, nationality, hobbies, and/or interests. The registration process may also include the user entering languages that the user speaks and/or feels comfortable receiving information in. By collecting such demographic information and storing such information in an accessible database and/or data file, such personal characteristics of a user may be considered when assessing the geo-demographic tags may be associated with a particular piece of spatially associated information. In one embodiment, a user may change his or her demographic information at any time, thereby allowing a single user to be alerted/granted access to possibly different information files.

Also illustrated in FIG. 1 is a Global Positioning System (GPS) 120 is commonly used in some embodiments, for tracking the location of portable computing devices such as device 111. Global Positioning System (GPS) technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar Global Positioning System (GPS) will be discussed with reference to the disclosure contained herein. However, other positioning systems are also contemplated for use as desired. For GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

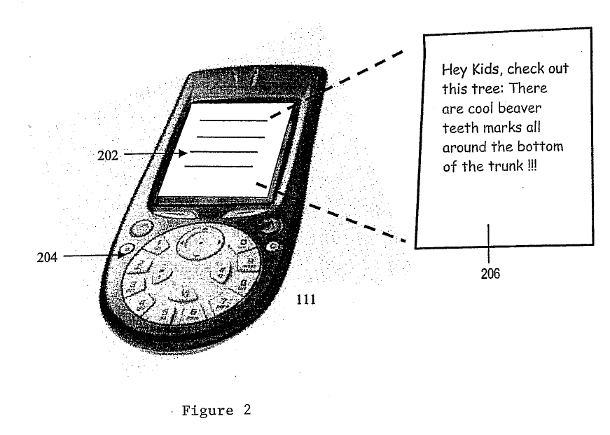

As illustrated in FIG. 2, a portable computing device 111 configured with appropriate SAS client circuitry to support the embodiments disclosed herein. As shown in FIG. 2, the portable computing device 111 may take the form of a handheld device such as a cell phone or PDA and includes a display 202 and user interface controls 204. Such a portable computing device 111 contains the aforementioned SAS client circuitry and is thereby operative to exchange information with the SAS server 100 over a communication link. The communication link may take any common form—for example a wireless communication link to an information network such as the Internet. The portable computing device includes a user interface including display features and user input features. In typical embodiments, a graphical user interface is enabled upon the display 202 that allows users to enter information and/or make selections to configure and/or direct the SAS client circuitry. In addition the display 202 of the portable computing device 111 is also to present visual contents of spatially associated information that may be accessed by the user. In the example shown in FIG. 2, the display 202 shows a virtual note 206 left in a local park by a child who goes to Washington Elementary School. The information is associated with a spatial location within the park and is associated with a geo-demographic tag that indicates it will trigger alerts and/or provide access only to other students of Washington Elementary school.

Portable computing device 111 may also be equipped to provide an alert or other alarm for capturing the attention of a user. In one embodiment, the portable computing device 111 may be equipped to provide such an alert or other alarm by providing sound information to alert the user to the presence of a piece of spatially associated information. In one embodiment, the portable computing device 111 may include one or more haptic actuators to provide such an alert or other alarm by producing a tactile sensation to alert the user to the presence of a piece of spatially associated information. Examples of haptic actuators and haptic control electronics for delivering haptic sensations to a user is disclosed in issued U.S. Pat. No. 6,211,861 which was co-invented by Rosenberg (the same inventor as this current disclosure) and is hereby incorporated by reference. In one embodiment, the portable computing device 111 may include one or more electro-tactile simulators to provide such an alert or other alarm by producing a mild electrical stimulus to alert the user to the presence of spatially associated information. In one embodiment, the portable computing device 111 may include one or more illuminated elements and/or graphical displays to provide such an alert or other alarm that alerts the user to the presence of a piece of spatially associated information. In one embodiment, an alert or other alarm may also be multi-modal, signaling the user with a combination of visual, aural, and/or tactile stimulation.

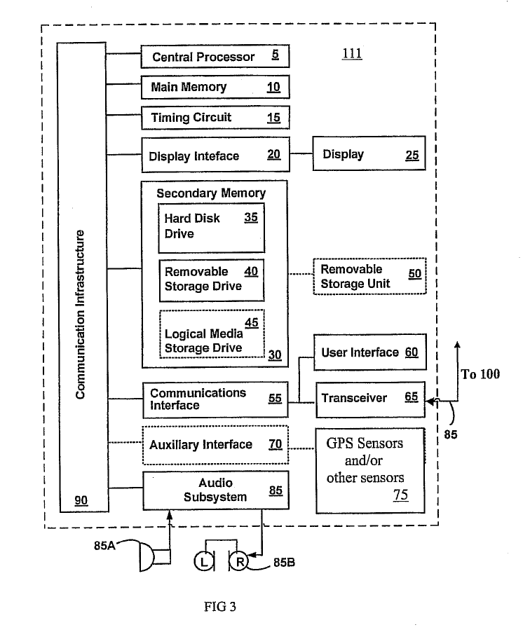

Referring to FIG. 3, a generalized block diagram of a portable computing device 111 is depicted. The portable computing device 111 includes a communications infrastructure 90 used to transfer data, memory addresses where data items are to be found and control signals among the various components and subsystems of the portable computing device 111.

A central processor 5 is provided to interpret and execute logical instructions stored in the main memory 10. The main memory 10 is the primary general purpose storage area for instructions and data to be processed by the central processor 5. The main memory 10 is used in its broadest sense and includes RAM, EEPROM and ROM. A timing circuit 15 is provided to coordinate activities within the media player. The central processor 5, main memory 10 and timing circuit 15 are directly coupled to the communications infrastructure 90.

A visual display interface 20 is provided to drive a visual display 25 associated with the portable computing device 111. The visual display interface 20 is electrically coupled to the communications infrastructure 90 and provides signals to the visual display 20 for visually outputting both graphics and alphanumeric characters. The display interface 20 may include a dedicated graphics processor and memory to support the displaying of graphics intensive media. The display 20 may be of any type (e.g., cathode ray tube, gas plasma) but in most circumstances will usually be a solid state device such as liquid crystal display. A secondary memory subsystem 30 is provided which houses retrievable storage units such as a hard disk drive 35, a removable storage drive 40, an optional a logical media storage drive 45 and an optional removal storage unit 50.

The removable storage drive 40 may be a replaceable hard drive, optical media storage drive or a solid state flash RAM device. The logical media storage drive 45 may be flash RAM device, EEPROM encoded with playable media, or optical storage media (CD, DVD). The removable storage unit 50 may be logical, optical or of an electromechanical (hard disk) design.

A communications interface 55 subsystem is provided which allows for standardized electrical connection of peripheral devices to the communications infrastructure 90 including, serial, parallel, USB, and Firewire connectivity. For example, a user interface 60 and a transceiver 65 are electrically coupled to the communications infrastructure 90 via the communications interface 55. For purposes of this disclosure, the term “user interface” 60 includes the SAS client circuitry that, in turn, enables a user to execute procedures on the portable computing device 111 and provides the means by which the portable computing device 111 displays information to the user.

The user interface 60 employed on the portable computing device 111 may include a haptic unit (not shown); a pointing device (not shown) such as a mouse, thumbwheel or track ball, an optional touch screen (not shown); one or more pushbuttons (not shown); one or more sliding or circular rheostat controls (not shown) and one or more switches (not shown.) One skilled in the art will appreciate that the user interface devices which are not shown are well known and understood.

The portable computing device also includes one or more sensors 75 for tracking the spatial location of the device in the physical world. The sensors often include a GPS transducer although other absolute spatial tracking sensors may be used. In addition, orientation sensors such as magnetometer sensors and/or accelerometer sensors may be used. The sensors may also include a digital temperature sensor for measuring the ambient temperature. The sensors may be internal to the portable computing device or a portion thereof. The sensors may also be external peripherals connected to the portable computing device and maintained local to the user such that they track the user's position and/or orientation within the physical world. The sensors may interface directly with the communication interface or may connect through an optional auxiliary interface 70 to couple such sensors to the communications infrastructure 90.

The transceiver 65 facilitates the remote exchange of data and synchronizing signals between the portable computing device and other computing devices, including a remote server acting as the SAS server. The transceiver 65 may be of a radio frequency type normally associated with computer networks for example, wireless computer networks based on BlueTooth (TM) or the various IEEE standards 802.11.sub.x., where x denotes the various present and evolving wireless computing standards. Alternately, digital cellular communications formats compatible with for example GSM, 3G and evolving cellular communications standards. Both peer-to-peer (PPP) and client-server models are envisioned for implementation of the embodiments disclosed herein. In a third alternative embodiment, the transceiver 65 may include hybrids of computer communications standards, cellular standards and evolving satellite radio standards.

Whether a user of a particular portable computing device may gain access to the SAS server depends in some embodiments upon that user being a registered user of the SAS service.

As used herein, “portable computing device” should be broadly construed as including any mobile wireless client device, e.g., a cell phone, pager, a personal digital assistant (PDA, e.g., with GPRS NIC), a mobile computer with a smartphone client, or the like. A typical portable computing device is a wireless access protocol (WAP)-enabled device that is capable of sending and receiving data in a wireless manner using the wireless application protocol. The wireless application protocol (“WAP”) allows users to access information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-band width constraints of a wireless networks. In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. In an illustrated embodiment, mobile device users use SMS, which is a text message service that enables short messages (e.g., generally no more than 140-160 characters in length) to be sent and transmitted from a portable computing device. Embodiments disclosed herein are not limited to mobile device users who have WAP-enabled devices or to use of any particular type of wireless network. Such devices and networks are merely illustrative; any wireless data communication technology now known or hereafter developed may be used in connection with the embodiments disclosed herein.

Lastly, an audio subsystem 85 is provided and electrically coupled to the communications infrastructure 90. The audio subsystem provides for the playback and recording of digital media, for example, multi or multimedia encoded in any of the exemplary formats MP3, AVI, WAV, MPG, QT, WMA, AIFF, AU, RAM, RA, MOV, MIDI, etc. Such media files may be spatially associated such that they are accessed by the user of the portable computing device as a function of his or her current spatial location in the physical world. The audio subsystem includes a microphone input port 85A and a headphone or speaker output port 85B. Connection of the microphone 85A and/or headset 85B includes both traditional cable and wireless arrangements known in the art. As referred to in this specification, “media” refers to video, audio, streaming and any combination thereof. In addition, the audio subsystem is envisioned to optionally include features such as graphic equalization, volume, balance, fading, base and treble controls, surround sound emulation, and noise reduction. One skilled in the art will appreciate that the above cited list of file formats is not intended to be all inclusive.

The portable computing device 111 includes an operating system, the necessary SAS client circuitry necessary to fully utilize the devices coupled to the communications infrastructure, media playback and recording applications and at least one SAS client program operatively loaded into main memory 10. Optionally, the portable computing device is envisioned to include at least one remote authentication application, one or more cryptography applications capable of performing symmetric and asymmetric cryptographic functions, and secure messaging software. Not shown is the SAS server which may be a single computer or a plurality of computers. Portable computing device 111 is coupled to SAS by a bidirectional communication link 85. The bidirectional communication link sends signals in either direction between server and the portable computing device. Microprocessor 5 is also operative to read data from sensors 75 which includes at least one locative sensor that tracks the current spatial location of the portable computing device. In common embodiments the locative sensor is a GPS transducer as described previously. Other sensors may include magnetometer orientation sensor and/or accelerometer pitch sensors and/or temperature sensors for outdoor temperature. Suitable microprocessors for use as local microprocessor 110 include the MC68HC711E9 by Motorola, the PIC16C74 by Microchip, and the 82930AX by Intel Corp. Microprocessor 110 can include one microprocessor chip, multiple processors and/or co-processor chips, and/or digital signal processor (DSP) capability. Not shown in the figure is the power source which is likely rechargeable batteries.

Microprocessor 5 provides signals to the display elements of the device (visual, audio, and/or tactile) causing the display to produce alerts to the user. The alerts may be determined by circuitry supported by the portable computing device, by circuitry supported by the SAS server, or by a combination of operations performed on both platforms. For example, in one embodiments, (as will be discussed in more detail to follow), the SAS server receives locative data from the portable computing device over link 85 and derives based upon the locative data and the information stored in the SAS database (as described previously) whether or not an alert should be imparted upon the user at the current time. Under such a paradigm, the local microprocessor 5 reports locative data to the SAS server describing the position of the portable computing device in physical space as well as optionally describing the direction of motion, speed of motion, and/or orientation of the portable computing device within the real physical environment. Based upon the locative data received from portable computing device the SAS server determines if the user is within a certain proximity of any spatially associated information by cross referencing locations within the SAS database. The SAS server also considers any linked geo-demographic tags and/or geo-ambient tags that may be associated with any spatially associated information within the user's proximity and determines if the user is to be alerted to any such spatially associated information.

Depending upon the conditions considered, additional information may be sent to the SAS server and/or accessed by the SAS server. For example, with respect to certain geo-ambient tags the SAS server may access weather data for the particular location of the user by accessing a weather data website and indexing current weather data by GPS location. Also the SAS server requires demographic information about the user to access any geo-demographic tags. Such information may be sent from the portable computing device to the SAS information as required or such information may be stored upon the SAS server in a user information database that is indexed by a unique user ID or other identifier for each user. The information stored in such a database may be entered by the user upon a registration process with the inventive service. There are a number of ways such a user information database may be maintained. In some embodiments each user is indexed by a unique user ID or other identifier. Relationally stored with respect to such a unique user ID includes various pieces of demographic information about the user. An example data structure is provided below for illustrative purposes only:

User[ID].age

User[ID].gender

User[ID].marital_status

User[ID].grade_level

User[ID].school_affiliation[i]

User[ID].political_party_affiliation

User[ID].business_affiliation[i]

User[ID].profession_catagory

User[ID].job_title

User[ID].highest_level_of_education

User[ID].hobby[i]

User[ID].interest[i]

User[ID].club_membership[i]

User[ID].team_affiliation[i]

User[ID].sexual_orientation

User[ID].organizational_affiliation[i]

User[ID].income_level

User[ID].nationality

User[ID].spoken_language[i]

User[ID].family_affiliation[i]

User[ID].friends_ID[i]

User[ID].number_of_dependents

User[ID].ages_of_dependents[i]

In this way, the user information database stores a plurality of pieces of demographic information about each user, indexed with respect to a unique user ID. The SAS server can thereby access demographic information about a user when passed the unique user ID. The unique user ID can be server specific and thereby maintain the anonymity of a particular user. In this way, the portable computing device 111 can pass to the SAS server over communication link 85 the unique user ID for the user of that portable computing device. The SAS server, upon receiving the unique user ID can reference any required demographic characteristics of that user as stored in the user information database. In some embodiments, user demographic information is instead stored locally upon the portable computing device of the user as one or more data files. Such a configuration has the benefit of being more private for the user, but may require that more information is passed back and forth between the SAS server and the portable computing device to perform the spatial association methods described herein.

As mentioned previously, the SAS server also maintains and/or accesses an SAS database which is a database that relates particular information files with particular spatial locations and/or areas within the real physical world. The SAS database also includes one or more geo-demographic tags and/or geo-ambient tags for each information file within the SAS database. The SAS database may also store user directional, user motion, and/or user proximity requirements that describe the direction(s) of the user, the direction(s) of speed(s) of user motion, and/or the proximity distance(s) of the user that is required for that user to be alerted to and/or granted access to a piece of spatially associated information. There are a number of ways such a SAS database may be maintained. In some embodiments, each unique information file is indexed by a unique information ID or other identifier. Relationally stored with respect to such an ID includes various pieces of aforementioned information. An example data structure is provided below for illustrative purposes:

Info[ID].latitude_coordinate[i]

Info[ID].longitude_coordinate[i]

Info[ID].altitude_coordinate[i]

Info[ID].required_proximity_distance[i]

Info[ID].required_user_orientation[i]

Info[ID].required_max_user_speed[i]

Info[ID].required_user_direction_of_motion[i]

Info[ID].expiration_date

Info[ID].proximity_area_parameters[i]

Info[ID].demographic_tag.required_gender

Info[ID].demographic_tag.required_min_grade_level

Info[ID].demographic_tag.required_max_grade_level

Info[ID].demographic_tag.required_min_age

Info[ID].demographic_tag.required_max_age

Info[ID].demographic_tag.required_min_income_level

Info[ID].demographic_tag.required_max_income_level

Info[ID].demographic_tag.required_profession

Info[ID].demographic_tag.required_hobby[i]

Info[ID].demographic_tag.required_interest[i]

Info[ID].demographic_tag.required_political_affiliation

Info[ID].demographic_tag.required_school_affiliation

Info[ID].demographic_tag.required_organizational_affiliation[i]

Info[ID].demographic_tag.required_team_affiliation[i]

Info[ID].demographic_tag.required_sexual_orientation

Info[ID].demographic_tag.required_nationality

Info[ID].demographic_tag.required_language[i]

Info[ID].demographic_tag.required_club_membership[i]

Info[ID].demographic_tag.required_famility_affiliation[i]

Info[ID].demographic_tag.required_friend[i]

Info[ID].ambient_tag.required_time_of_day[i]

Info[ID].ambient_tag.required_day_of_week[i]

Info[ID].ambient_tag.required_month_of_year[i]

Info[ID].ambient_tag.required_season_of_year[i]

Info[ID].ambient_tag.required_min_temperature

Info[ID].ambient_tag.required_max_temperature

Info[ID].ambient_tag.required_cloud_conditions

Info[ID].ambient_tag.required_precipitation_conditions

Info[ID].ambient_tag.required_smog_index

Info[ID].ambient_tag.required_UV_index

Info[ID].ambient_tag.required_pollen_count

In this way, the SAS database can link an information file with spatial association data identifying a particular spatial location in the physical world and/or a particular area in the physical world. In this way, the SAS database can link required user proximity parameters, orientational parameters, direction of motion parameters, and/or speed of motion parameters required of a user to be alerted to and/or gain access to a particular piece of spatially associated information. In this way, the SAS database may link a particular piece of spatially associated information with one or more required demographic characteristics of users who are to be alerted to and/or granted access to that information file. Also in this way, the SAS database may link a particular piece of spatially associated information with one or more required ambient characteristics of the environment of the user who are to be alerted to and/or granted access to that information file. For most information files referenced by the SAS database, only a small number of demographic tags and/or ambient tags are assigned specific values. The rest are left null and are not considered in the assessment process that limits alerts and/or access to certain users based upon their demographic and ambient environmental conditions.

In addition to the above database data entries, the SAS database generally also includes a data structure that associates particular information files by their unique ID to a structure indexed by the associated GPS coordinates. This data structure is referred to herein as the Information_Location_Index. These coordinates may be indexed by latitude and longitude and may optionally include elevation as well. In this way, by knowing the current latitude, longitude, and elevation of a user of a portable computing device, the SAS server can access the database and determine the all of the unique IDs for all of the information files that are linked to locations within some range of those coordinates. Once the set of unique IDs are known, the associated proximity parameters, mobility tags, geo-demographic tags, and/or geo-ambient tags for each information file in that range can be assessed. Based upon the current location of the user (as determined by sensors on the portable computing device) and optionally the current direction and motion of the user (as also determined by sensors on the portable computing device) and any whether or not any geo-demographic tags and/or geo-ambient tags are satisfied, the user is alerted to and/or provided access to certain of the identified information files.

To make the process more clear, consider an exemplary scenario involving databases and data structures such as the ones shown above: A twelve year old boy takes a walk within a state park and has a portable computing device upon his person. The particular device is a cell phone enabled with a web browser and a GPS transducer. The boy has access to a broadband cellular network over the personal computing device and is connected to an SAS server. Previously he set up an account on the SAS server by filling out a registration page using a web browser. During the registration process he entered demographic information about himself, including the fact that he is 12 years old, is in 6th grade, goes to Washington Middle School, plays soccer and collects rocks and is interested in marine biology. He is also a member of the Junior National Geographic Society. Upon entering this information he was given a unique user ID number (166852) which was stored in memory upon his portable computing device. His demographic data is stored in a user information database upon the SAS server. The data is stored in an example data structure as follows:

User[166852].age=12

User[166852].gender=male

User[166852].marital_status=unmarried

User[166852].grade_level=6

User[166852].school_affiliation[1]=Washington Middle School

User[166852].political_party_affiliation=NULL

User[166852].hobby[1]=soccer

User[166852].hobby[2]=rock collecting

User[166852].interest[1]=marine biology

User[166852].nationality=American

User[166852].spoken_language[1]=English

As the boy walks about the park, the GPS sensor on board his portable computing device updates locative data being accessed by the processor with updated latitude, longitude, and elevation coordinates. Whenever his location changes by more than 8 feet in any direction, his current coordinates are sent to the SAS server along with us unique ID number. The SAS server accesses the Information_Location_Index on the SAS server, using the locative coordaintes received from the portable computing device of the boy. The Information_Location_Index returns information ID values for any information files that are within 100 feet of the user in any direction. In this case, there is a set of 22 pieces of spatially associated information within 100 feet of the boy at the current time. Thus, a list of 22 information ID numbers are returned to the SAS server circuitry upon accessing the Information_Location_Index. This set of 22 information ID numbers is then used to access the SAS database so as to determine if the user should be alerted to and/or permitted access to any of the 22 pieces of spatially associated information. This is performed as follows: For each of the 22 ID numbers, the SAS database is accessed and data is accessed about the specific location of the piece of spatially associated information as well as any directional, motion, speed, area, and/or proximity requirements for the information. For example, the first information file in the set of this example is information ID=54455652. Using this ID, the following information is accessed (the null variables are not shown):

Info[54455652].latitude_coordinate[1]=35.2332

Info[54455652].longitude_coordinate[1]=117.2665

Info[54455652].altitude_coordinate[1]=120 ft

Info[54455652].required_proximity_distance=20 feet

Info[54455652].demographic_tag.required_min_grade_level=10

Thus, for this particular information file, the user must be within 20 feet of the linked coordinates and must be at least in 10th grade. Presumably this is because the sophistication of the information is such that it is not appropriate for anyone who is below a 10th grade educational level. The SAS server circuitry, considering the current spatial coordinates from the user's portable computing device and the spatial association coordinates of the current information file, determines that the user is 17 feet away and thus within the required proximity range. This computation is performed by simply converting latitude and longitude coordinates to feet and performing a vector subtraction of the coordinates. The SAS server circuitry also compares the user's grade level as stored in the user information database and indexed by the user's ID number with the required geo-demographic-condition in the SAS database and determines that the user must be at least in grade 10 but does not meet this condition for his demographic data indicates that he is in grade 6. Thus, the user is not alerted to this information file and is not provided access to it.

The process then repeats for the next of the each 22 ID numbers. Again, the SAS database is accessed and data is retrieved about the specific location of the piece of spatially associated information as well as any directional, motion, speed, area, and/or proximity requirements for the information. For example, the second information file in the set of this example is information ID=38248522. Using this ID, the following information is accessed (the null variables are not shown):

Info[38248522].latitude_coordinate[1]=35.2331

Info[38248522].longitude_coordinate[1]=117.2666

Info[38248522].altitude_coordinate[1]=125 ft

Info[38248522].required_proximity_distance=28 feet

Info[38248522].demographic_tag.required_min_grade_level=5

Info[38248522].demographic_tag.required_max_grade_level=8

Info[38248522].demographic_tag.required_club_membership=Junior National Geographic Society

Thus, for this particular information file, the user must be within 28 feet of the linked coordinates and must be in a grade level between 5th and 8th. Presumably this is because the sophistication of the information is such that it is most appropriate for kids who are between 5th and 8th grade in education level. This particular information file is also requires club membership in the Junior National Geographic Society. Presumably this is because this information was created and linked by someone affiliated with the organization for other members of the organization.

The SAS server circuitry, considering the current spatial coordinates from the user's portable computing device and the spatial association coordinates of the current information file, determines that the user is 21 feet away and thus within the required proximity range. This computation is performed by simply converting latitude and longitude coordinates to feet and performing a vector subtraction of the coordinates. The SAS server circuitry also compares the user's grade level as stored in the user information database and indexed by the user's ID number with the required geo-demographic-condition in the SAS database and determines that the user satisfies the required demographic condition. The SAS server circuitry also compares the user's club membership characteristics with the geo-demographic requirement that user's be members of the Junior National Geographic Society and determines that the user satisfies this demographic condition. It is thus determined that the user is to be provided an alert to the information and/or provided access to the information. This is achieved by the SAS server sending data to the portable computing device of the user. The data indicates that a piece of spatially associated information is within a certain proximity of the user and that the information is relevant to the user. This data may simply be an encoded message to this effect. Upon receiving the encoded message the portable computing device displays an alert to the boy. This can be a visual message, an audio sound, and/or a tactile sensation. In this particular example it is an audio beeping sound that alerts the boy. He then looks at the screen of his portable computing device and sees a displayed message indicating that a piece of spatially associated information has been found in his proximity and asking him to accept or reject receipt. He uses the user interface of his portable computing device to accept receipt. This acceptance causes a message to be sent from the portable computing device to the SAS server indicating that the user has accepted receipt of the particular piece of spatially associated information. Upon receiving this message the SAS server access the piece of spatially associated information and transmits it to the portable computing device. Upon receiving the piece of spatially associated information, the portable computing device displays it to the user and/or displays a prompt to the user asking if the user desires to view it. In this case it is a 30 second video file that shows a national geographic scientist talking about a particular type of tree that is near to the user. The boy watches the video and learns about that type of tree. The above process also repeats for the remaining 20 information files to determine if any other information files should be alerted and/or displayed to the user based upon his location along with his demographic characteristics and/or the ambient characteristics of his immediate surroundings. In some embodiments, all 22 information files are considered prior to any being alerted and/or displayed such that if a plurality of information files are matched to the user they may be ordered and/or prioritized in how they are presented to the user based upon the degree of the match, the proximity to the user, or some other prioritization method.

As illustratively described above, a user can be provided with a customized information experience in a spatial environment, being provided with information that is spatially linked to locations in his vicinity that is also demographically targeted at him. In this case, the spatial association system provided the user with a particular information file about his immediate vicinity from a plurality of information file related to his immediate vicinity, the particular piece being a grade-appropriate information segment from an club to which he was a member.

While embodiments herein disclosed has been described by means of specific examples and applications thereof, numerous modifications and variations could be made thereto by those skilled in the art without departing from the scope of the invention set forth in the claims.

What is claimed is:

1. A spatial association method, comprising:
receiving geographic coordinates identifying a current physical location of a mobile computing device of a user;
receiving demographic information identifying at least one current demographic characteristic of the user;
accessing a database containing a plurality of information files, each of the plurality of information files being linked with at least one spatial coordinate and at least one geo-demographic tag;
determining whether the physical location identified by the received geographic coordinates has a predetermined relationship with at least one spatial coordinate to which the plurality of information files are linked;
determining whether at least one demographic characteristic identified by the received demographic information matches at least one geo-demographic tag to which the plurality of information files are linked; and
transmitting an association message to the mobile computing device, the association message adapted to alert the user via the mobile computing device as to the presence of any information files linked both to at least one spatial coordinate determined to have the predetermined relationship with the physical location identified by the received geographic coordinates and to at least one geo-demographic tag determined to match at least one demographic characteristic identified by the received demographic information.

2. The spatial association method of claim 1, wherein the received demographic information identifies at least one demographic characteristic selected from the group consisting of gender, age, age range, highest level of education, current grade level, and school affiliation.

3. The spatial association method of claim 1, wherein the received demographic information identifies at least one demographic characteristic selected from the group consisting of hobby, interest, political affiliation, club affiliation, team affiliation, organizational affiliation, and professional affiliation.

4. The spatial association method of claim 1, wherein the received demographic information identifies at least one demographic characteristic selected from the group consisting of gender, marital status, sexual orientation, membership to a particular circle of friends, family affiliation, income level, number of dependents, and age of dependents.

5. The spatial association method of claim 1, wherein the received demographic information identifies at least one demographic characteristic associated with each of a gender characteristic and either an age characteristic or grade level characteristic.

6. The spatial association method of claim 1, wherein at least one of the plurality of information files contained within the database are further linked with at least one geo-ambient tag, the method further comprising:
accessing ambient information identifying at least one ambient condition present at the current physical location of the mobile computing device of the user;
determining whether at least one ambient condition identified by the received ambient information matches at least one geo-ambient tag to which at least one of the information files are linked when at least one spatial coordinate is determined to have the predetermined relationship with the physical location identified by the received geographic coordinates; and
transmitting an association message to the mobile computing device, the association message adapted to alert the user via the mobile computing device as to the presence of information files further linked to at least one geo- ambient tag matching at least one ambient condition identified by the accessed ambient information.

7. The spatial association method of claim 6, wherein the accessed ambient information identifies at least one ambient condition selected from the group consisting of a weather condition and a season-of-year.

8. The spatial association method of claim 7, wherein the at least one weather condition is selected from the group consisting of air temperature, air temperature range, cloud cover, presence of precipitation, current type of precipitation, current chance of precipitation, presence of fog, presence of storms, wind conditions, sun conditions, recent accumulation of precipitation, UV index, smog conditions, and pollen count.

9. The spatial association method of claim 6, wherein the accessed ambient information identifies at least one ambient condition selected from the group consisting of time-of-day, day-of-week, and month-of-year.

10. The spatial association method of claim 1, wherein at least one of the plurality of information files contained within the database are further linked with at least one mobility tag, the method further comprising:
receiving mobility information identifying at least one mobility condition of the mobile computing device;
determining whether at least one mobility condition identified by the received mobility information matches at least one mobility tag to which at least one of the information files are linked when at least one spatial coordinate is determined to have the predetermined relationship with the physical location identified by the received geographic coordinates; and
transmitting an association message to the mobile computing device, the association message adapted to alert the user via the mobile computing device as to the presence of information files further linked to at least one mobility tag matching at least one ambient condition identified by the received mobility information.

11. The spatial association method of claim 10, wherein the received mobility information identifies at least one mobility condition selected from the group consisting of current speed of motion and range of speeds of motion.

12. The spatial association method of claim 10, wherein the received mobility information identifies at least one mobility condition selected from the group consisting of current direction of motion, range of directions of motion, trajectory of motion, and range of trajectories of motion.

13. The spatial association method of claim 10, wherein the received mobility information identifies at least one mobility condition selected from the group consisting of current orientation and range of orientations.

14. The spatial association method of claim 1, wherein the association message is adapted to cause the mobile computing device to provide at least one of a visual, auditory, and tactile alert to the user.

15. The spatial association method of claim 1, wherein the association message is further adapted to inform the user via the mobile computing device as to at least one of the type, importance, relevance, and proximity of the information file.

16. The spatial association method of claim 1, wherein the predetermined relationship is a requirement that the current physical location is within a certain proximity of the at least one spatial coordinate.

17. The spatial association method of claim 1, wherein the predetermined relationship is a requirement that the current physical location is within a defined area or defined volume associated with the at least one spatial coordinate.

18. A spatial association method, comprising:
receiving geographic coordinates identifying a current physical location of a mobile computing device of a user;
accessing ambient information identifying at least one ambient condition present at the current physical location of the mobile computing device of the user;
accessing a database containing a plurality of information files, each of the plurality of information files being linked with at least one spatial coordinate and at least one geo-ambient tag;
determining whether the physical location identified by the received geographic coordinates has a predetermined relationship with at least one spatial coordinate to which the plurality of information files are linked;
determining whether at least one ambient condition identified by the received ambient information matches at least one geo-ambient tag to which at least one of the information files are linked when at least one spatial coordinate is determined to have the predetermined relationship with the physical location identified by the received geographic coordinates; and
transmitting an association message to the mobile computing device, the association message adapted to alert the user via the mobile computing device as to the presence of any information files linked both to at least one spatial coordinate determined to have the predetermined relationship with the physical location identified by the received geographic coordinates and to at least one geo-ambient tag matching at least one ambient condition identified by the accessed ambient information.

19. The spatial association method of claim 18, wherein the accessed ambient information identifies at least one ambient condition selected from the group consisting of a weather condition and a season-of-year.

20. The spatial association method of claim 19, wherein the at least one weather condition is selected from the group consisting of air temperature, air temperature range, cloud cover, presence of precipitation, current type of precipitation, current chance of precipitation, presence of fog, presence of storms, wind conditions, sun conditions, recent accumulation of precipitation, UV index, smog conditions, and pollen count.

21. The spatial association method of claim 18, wherein the accessed ambient information identifies at least one ambient condition selected from the group consisting of time-of-day, day-of-week, and month-of-year.

22. The spatial association method of claim 18, wherein the association message is adapted to cause the mobile computing device to provide at least one of a visual, auditory, and tactile alert to the user.

23. The spatial association method of claim 18, wherein the association message is further adapted to inform the user via the mobile computing device as to at least one of the type, importance, relevance, and proximity of the information file.

24. The spatial association method of claim 18, wherein the predetermined relationship is a requirement that the current physical location is within a certain proximity of the at least one spatial coordinate.

25. The spatial association method of claim 18, wherein the predetermined relationship is a requirement that the current physical location is within a defined area or defined volume associated with the at least one spatial coordinate.

26. A spatial association method, comprising:
receiving geographic coordinates identifying a current physical location of a mobile computing device of a user;
receiving current speed information of the mobile computing device;
accessing a database containing a plurality of information files, each of the plurality of information files being linked with at least one spatial coordinate and at least one speed-related mobility tag;
determining whether the physical location identified by the received geographic coordinates has a predetermined relationship with at least one spatial coordinate to which the plurality of information files are linked;
determining whether the current speed matches at least one mobility tag to which at least one of the information files are linked when at least one spatial coordinate is determined to have the predetermined relationship with the physical location identified by the received geographic coordinates; and
transmitting an association message to the mobile computing device, the association message adapted to alert the user via the mobile computing device as to the presence of any information files linked both to at least one spatial coordinate determined to have the predetermined relationship with the physical location identified by the received geographic coordinates and to at least one mobility tag matching the current speed.

27. The spatial association method of claim 26, wherein the current speed is determined to match the at least one mobility tag if the current speed is below a certain speed level.

28. The spatial association method of claim 26, wherein the current speed is determined to match the at least one mobility tag if the current speed is within a certain speed range.

29. The spatial association method of claim 26, wherein the current speed is determined to match the at least one mobility tag if the current speed is above a certain speed level.

30. A spatial association system, comprising:
a server containing circuitry adapted to:
receive geographic coordinates identifying a current physical location of a mobile computing device of a user;
receive current demographic information identifying at least one current demographic characteristic of the user;
access a database containing a plurality of information files, each of the plurality of information files being linked with at least one spatial coordinate and at least one geo-demographic tag;
determine whether the physical location identified by the received geographic coordinates has a predetermined relationship with at least one spatial coordinate to which the plurality of information files are linked;
determine whether at least one demographic characteristic identified by the received demographic information matches at least one geo-demographic tag to which the plurality of information files are linked; and
transmit an association message to the mobile computing device, the association message adapted to alert the user via the mobile computing device as to the presence of any information files linked both to at least one spatial coordinate determined to have the predetermined relationship with the physical location identified by the received geographic coordinates and to at least one geo-demographic tag determined to match at least one demographic characteristic identified by the received demographic information.

31. The spatial association system of claim 30, wherein the association message is adapted to cause the mobile computing device to provide at least one of a visual, auditory, and tactile alert to the user.

32. The spatial association system of claim 30, wherein the association message is further adapted to inform the user via the mobile computing device as to at least one of the type, importance, relevance, and proximity of the information file.

33. The spatial association system of claim 30, wherein the predetermined relationship is a requirement that the current physical location is within a certain proximity of the at least one spatial coordinate.
